(19) United States
(12) Patent Application Publication
(10) Pub. No.: US 2021/0019642 A1
(43) Pub. Date: Jan. 21, 2021

(54) SYSTEM FOR VOICE COMMUNICATION WITH AI AGENTS IN AN ENVIRONMENT

(71) Applicant: Wingman AI Agents Limited, London (GB)

(72) Inventors: John Andrew O'Malia, Park City, UT (US); Ivan Goloskokovic, Belgrade (RS); Nikola Jovicic, Belgrade (RS); Dusan Josipovic, Belgrade (RS)

(73) Assignee: Wingman AI Agents Limited, London (GB)

(21) Appl. No.: 16/926,027

(22) Filed: Jul. 10, 2020

Related U.S. Application Data
(60) Provisional application No. 62/875,173, filed on Jul. 17, 2019.

(51) Int. Cl. G06N 5/04; G05D 1/10; G06F 3/16; G10L 25/30; G06F 40/20

(52) U.S. Cl. CPC G06N 5/04; G05D 1/101; G06F 40/20; G10L 25/30; G06F 3/167

(57) ABSTRACT

Systems and methods are provided that may generate, based on an agent neural network, actions and/or policies for an environment, the environment comprising an apparatus and/or a software component. The actions and/or the policies may be enacted in the environment. A human observation may be received (“hijacked”) from a voice network module. A natural language processing neural network may output encodings of labels for entities, actions, and/or policies, when the human observation and environment observations are supplied as input to the natural language processing neural network. The environment observations are indicative of states of the environment. A relational reasoning neural network may generate cross-modal embeddings from the environment observations and the encodings of labels for entities, actions, and/or policies. The agent neural network may generate the actions and/or the policies from the environment observation and the cross-modal embeddings.

This application is a non-provisional application of, and claims priority under 35 USC § 119(e) to, U.S. provisional application 62/875,173, filed Jul. 17, 2019, the entire contents of which are incorporated by reference.

### TECHNICAL FIELD

This application relates to the field of artificial intelligence, and in particular, to conveying human voice input to artificially intelligent agents which select and execute actions in a simulated or real-world environment on the basis of such human input.

### BACKGROUND

Present artificial intelligence systems suffer from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a schematic diagram of an example of a system for aligning action and/or policy selection by the AI Agent with human operator observations;

FIG. 2 is a data flow diagram for an example of the system;

FIG. 3 illustrates an example of training a semantic layer of the system;

FIG. 4 illustrates an example of training a generative layer of the system;

FIG. 5 illustrates an example of aligning human operator and agent saliency maps;

FIG. 6 illustrates an example of generative layer input and output;

FIG. 7 illustrates an example of human operator influence on agent reinforcement learning training;

FIG. 8 illustrates an example of human-directed AI agent input and output;

FIG. 9 shows an example of the entire system;

FIG. 10 shows an example of how the voice input from the human operator may be converted into a form which enables the agent to select actions which are compliant with the human input; and

FIG. 11 shows a specific example of hijacking a voice network module in order to obtain the human observation in voice format.

### DETAILED DESCRIPTION

This specification relates to a method for directly communicating voice input to an AI agent in a real or simulated environment and processing it within the environment in such a way that the agent can successfully interpret human intent in the context of the environment in which it operates. The system works without the voice input being pre-processed outside of the environment in which the agent operates.

The AI agents referred to in this application may include neural networks and/or deep-learning or reinforcement-learning agents which receive observations about the environment in which they operate, and which select and perform actions within that environment.

The environment may be a simulated environment or a real-world environment, and may contain elements of both. A simulated environment may refer to a game or a simulation of any real or imagined environment. AI agents may learn to observe and act in a simulated environment and be deployed in a real environment, or vice-versa, or may both learn and be deployed in either type of environment entirely.

The human operator referred to in this application is also able to observe the environment, or parts of the environment. The human operator's view of the environment may be partly or entirely shared by the AI agent, and may be differently or similarly represented to human and AI Agent(s).

This application incorporates a system for creating a joint understanding between human operator and AI Agent in regard to the intent of human input in the context of the environment and environment state, and the entities and dynamics which may exist therein at any given point in time, as well as the relationships and interactions between these entities and dynamics.

This specification describes a method to interpret natural-language voice input from a human operator into a goal which directly affects the actions of the AI Agent to enact or act in a compatible way with the human operator input, and for all of these things to happen within the real-world environment or simulation platform.

The NLP engine refers to a neural-network within the game or simulation engine, or within the real-world environment if applicable, which maps natural human language, in the form of human voice, into a form such that the AI agent can utilize it to align its action selection with human intent.

Within this method it is possible for a human operator to input text into the human-machine interface, and for this text to be converted to voice to be sent into the environment for interpretation by the AI Agent within the environment. The application therefore also facilitates via this method the use of text to control the AI Agent.

U.S. patent application publication 2019/0108448 titled “Artificial Intelligence Framework” describes a method for merging human input with AI Agent actions. However, a novel challenge within such a system, which may occur when human input is to be conveyed to the AI agent, but is not able to be pre-processed from voice into a mathematical representation which aligns the AI Agent's reward function directly with the environment in a format which can understood by the agent before being conveyed to the AI Agent. In such a situation, where the AI Agent adapts directly to human voice input, it may be necessary to, entirely within the environment: a) deliver the human voice input to the AI Agent, and b) convert voice into a form that the AI Agent can use to align its action selections with human input. The method presented here is a novel solution to the specific challenge of conveying human voice input to an AI Agent which operates in an environment where it is not possible to externally pre-process the human input into a mathematical representation of the human input such as a vector, embedding, or text-based word representation before it is presented to the Agent.

Artificial Intelligence (“AI”) Agents, neural network Agents, and/or reinforcement learning algorithm Agents are generally referred to as “Agents.” The agent includes the AI in the form a one or more neural networks. The agent may control, for example, a player or any character that is allowed by a video game to be controlled. The agent may enact actions and/or policies in the video game. In some examples, the human observer may hand over control of the player to the agent and vice versa.

Heretofore, in order to deploy Agents, which are capable of learning to create actions or make decisions in a given environment using a neural network, a domain or environment is selected in which it is possible to execute or observe a very large number of action sequences, where such executions or observations create enough feedback about the relative success or value of such action sequences to lead to iterative improvement in the Agent's actions and strategy. The agents may be referred to as agents, reinforcement learning (“RL”), deep reinforcement learning (“DRL”), neural network, and/or AI agents interchangeably.

AI Agents are designed to predict and learn. For example, AI Agents may operate or learn through independent exploration of an environment (autonomous agents), and/or have been designed to follow or mimic the actions of another agent or element in the same or in a similar environment (imitation learning, curriculum learning, and related approaches).

In the past, an AI Agent using reinforcement learning and/or deep reinforcement learning has been trained such that, for a given environmental state, the AI Agent selects an action, a series of actions, and/or a policy, which results in some kind of action output from the AI Agent. Initially, the AI Agent selects such actions either randomly or based on initialized hyperparameters; next, the AI Agent seeks to gather feedback on the value or effectiveness of such actions, and backpropagates or adjusts the weights in the AI Agent's neural network in accordance with the value of the outcomes generated by its actions. On one hand, successful outcomes enhance the weights in the hidden layers of the network that led to the selected action. On the other hand, negative outcomes decrease the weights of the hidden layers of the neural network that led to the selected action. Over time, the goal of such systems may be that, through this iterative process, the action and/or policy selection of the neural network converges on successful strategies and selects the best action or policy for a given environmental state. Current state-of-the-art results are achieved by reinforcement learning algorithms such as PPO (proximal policy optimization, a policy gradient algorithm) as described in, for example, “Proximal Policy Optimization Algorithms” by John Shulman et al., and various Deep Q-Learning (DQN) variants such as Rainbow described in “Rainbow: Combining Improvements in Deep Reinforcement Learning” by Matteo Hessel et al. These approaches may require many thousands, hundreds of thousands, or even vastly more iterations in order to identify an appropriate action to be taken for a given state of the environment. In the course of such training, the AI Agent selects and performs a large number of actions that may be at odds with successful play, leading to long training times, high computational resource utilization, and the potential for never reaching a successful play strategy. Never reaching a successful play strategy is commonly known as a “failure to converge”. If long-range planning over many action steps or long-term strategy is required for successful outcomes, particularly where little feedback is provided or gained during training as to whether the Agent's actions are leading the agent toward optimal end goals, existing algorithms tend not to converge to successful behaviour and appropriate neural network weights.

Alternatively or in addition, current techniques do not enable human input to alter the Agent learning or action-selection processes in real-time. Current techniques fail to use human input (that is not in software coding form) to adapt or modify the AI Agent's action or policy selection for a given environment state, apart from stop/abort type commands to discourage future selection of a given action/state combination, or to force a new action selection by the neural network. Alternatively or in addition, current techniques also do not provide a mechanism by which a human's attention and priority vectors in a given environment scenario may be captured and mapped such that the Agent's action or policy selection process may be modified to be more aligned with that of the human's priorities and attention.

An alternative to this autonomous learning method for teaching AI Agents is imitation learning (and aligned approaches such as curriculum learning). During imitation learning and curriculum learning, the AI Agent may learn by observing actions of others acting in the same or similar environments, and in some examples, by receiving additional input or commentary or feedback from external sources, either human or via other input. Such an approach may lead to faster convergence to successful learning than autonomous learning methods. Such an approach has also led to successful deployments in environments, which are challenging for DRL/RL autonomous-learning agents. However, such approaches sometimes have problems with generalization, resulting instead with an overfitting problem (memorization of the specifics of the environment and the precise action for each state). In addition, if the environmental state and goal to be solved by the Agent has not already been encountered by or demonstrated to the AI Agent, it is possible that the Agent chooses either no action or a highly inappropriate action. Such systems often also exhibit a failure to generalize, meaning they fail to adapt successful behaviours when small environment changes are encountered, even because of trivial changes such as background color.

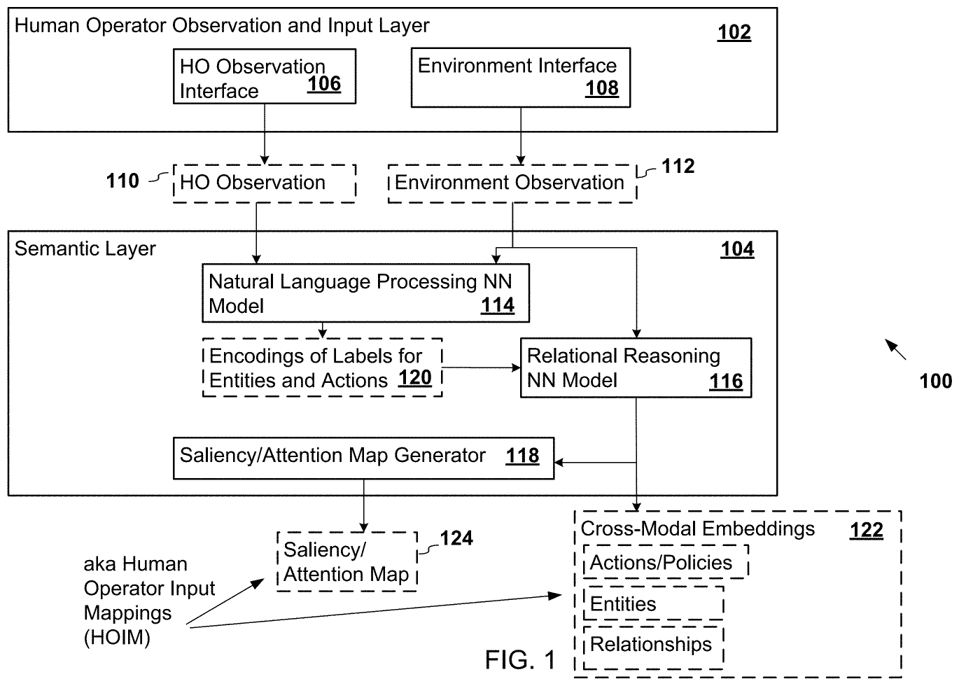

FIG. 1 is a schematic diagram of an example of a system 100 for aligning action and/or policy selection by the AI Agent with human operator observations. The system 100 shown in FIG. 1 includes a human operator observation and input layer 102 and a semantic layer 104.

In other examples, the system 100 may include additional, fewer or different components. For example, the system 100 may include a generative layer (not shown) and/or an agent layer (not shown), both of which are discussed later below in detail. In yet another example, the system 100 may include only components of the semantic layer 104.

By way of an initial introduction, the agent layer may include a neural network of the AI Agent. Once trained, this agent neural network is able to generate actions and/or policies to be enacted in an environment.

The environment may include any component in which, or to which, the AI Agent may carry out actions and/or policies selected by the AI Agent. The environment may include, for example, a video game, a robot, a drone, a vehicle, an aircraft, a watercraft, and any other apparatus and/or software component.

The human operator observation and input layer 102 may include a human observation interface 106 and an environment interface 108. The environment interface 108 is configured to generate environment observations 112.

The environment observations 112 may be indicative of one or more states of the environment, such as pixels and/or other visual representations, video, sounds, text, data, elements, user input controlling the environment such as mouse clicks, text commands, and graphical user interface information such as user selection information, and any other representations that are available to the AI Agent. In some examples, as described further below, the environment observations 112 may include agent representations of environment state, semantic labels of elements, semantic labels of actions, and/or generated sequences representing joint Agent and Human Operator input saliency mapping or predicted agent action.

In some examples, the environment interface 108 may obtain the environment observations 112 from an application programming interface (API) exposed by the environment or by some other component, such as the agent. Alternatively or in addition, the environment interface 108 may obtain the environment observations 112 from a video feed representing an output of a software component of the environment and/or a video feed from a camera pointing to an apparatus included in the environment.

In contrast, the human observation interface 106 is configured to generate one or more human observations 110, each representing an observation of the environment made by a human. The human observation 110 represents human input that the environment does not use to control the environment or an aspect within the environment. However, as explained in more detail below, the system 100 may enable the AI Agent to align its action and/or policy selection with the human observations 110, and the action and/or policy selected by the AI Agent may be performed in the environment. Examples of the human observations 110 may include verbal and/or text descriptions of the environment, instructions for the agent, and commentary on actions and/or policies selected by the agent, such as comments on game play where the environment includes a video game. An example of the human observation 110 may include text or audio such as “mine the minerals at the top of the screen to avoid attacks by the Zerglings at the bottom of the screen” or “the player may be able to avoid attacks by the Zerglings at the bottom of the screen if she mines the minerals at the top of the screen.” In another example, the human observation 110 may include data indicating an area of a screen selected by a user, such as data received from a graphical user interface.

In one example, a video of a previously played video game that includes audio commentary made by a human as the video game was played may be included in a video file, such as an MPEG file. The human observation interface 106 may extract the audio from the audio file, and output the audio as the human observations 110. In contrast, the environment interface 108 may extract the video from the video file and output the video as the environment observations 112.

The semantic layer 104 may include a natural language processing neural network (NLP NN) 114, a relational reasoning neural network 116, and a saliency/attention map generator 118. The natural language processing neural network 114 is configured to receive the human observations 106 and the environment observations 112, and generate encodings 120 of labels for elements, actions, and/or policies. The encodings 120 of the labels may indicate meanings of labels for elements, relationships, and actions. An example of the encodings 120 of labels may include vectors.

Elements may include any static (non-moving) objects and/or dynamic (moving) objects in the environment. For example, in a video game environment, the static elements may include barriers and components of territory such as walls, towers, and buildings, as well as elements that are portable, or may be collected or used by the agent.

Dynamic elements may include objects in the environment that may be controlled by a player and/or by the agent. In addition, the dynamic elements may include objects controlled by other players or other agents, such as in-game AI agents or rule-based agents, including actors in the environment, such as rule-based entities that have specific, static action mappers for given states of the environment. In a video game example, the dynamic elements may be “enemies”, friendly entities, and/or neutral entities.

Relationships may be any of a wide-range of interactions or relative positions of the elements and the player and/or the agent. In some examples, the relationships may refer only to position, in order to specify which of multiple enemies are to be targeted first in an attack. This may assist with disambiguation in instructions, similar to how humans clarify instructions between themselves. Alternatively or in addition, the relationships may refer to actions, which are being taken or are to be taken, regarding the elements (as well as the player/agent) in the environment. The relationships may also clarify interactions between the elements and a corresponding value of such interactions.

The following examples of the human observations 110 include identifications of the elements (EL) and the relationships (RE) added to the human observations 110: “Mine the minerals (EL) at the top of the screen (RE) to avoid attacks by the Zerglings (EL) at the bottom of the screen (RE);” “Move around the wall (EL) and attack the Terrans (EL) from the right with five Marines (EL);” “Collect minerals (EL) to boost your energy levels (EL);” and “Build (RE) marines (EL) until the Zerglings (EL) attack, then attack (RE) Zerglings (EL).”

The relational reasoning neural network 116 may be configured to generate cross-modal embeddings 122 from the environment observations 108 and the encodings 120 of labels for elements, actions, and/or policies from the natural language processing neural network 114. Cross-modal embeddings may be a data structure that embodies mathematical representations through which a neural network maps the relationships between multiple inputs or modes. In the system 100 described here, the inputs include the encoding 120 of labels and the environment observations 112. Therefore, the relational reasoning neural network 116 both “observes” actions enacted in the environment and “listens” to the human observations 110, which are connected to the actions the relational reasoning neural network 116 is “observing.” For example, video game data flows into the semantic layer 104 (and the agent) in visual and data form from the environment, and, at the same time, human input in the form of the human observations 110 is being mapped into the semantic layer 104.

The neural networks 114 and 116 in the semantic layer 104 create an enhanced state embedding, which not only refers to the elements and/or actions observed (and disentangled or separated into separate components by the relational reasoning neural network 116), but also refers to how the elements and/or actions are described by humans. As a result, the agent learns to “see” the environment and associate the relevant semantics with what the agents sees. The relational reasoning neural network 116 may compress this information into a lower-dimensional mathematical representation (such as vectors) which is referred to as the cross-modal embeddings 122. The cross-modal embeddings 122 may be referred to as a cross-modal embedding space, which merges the semantic and visual/API inputs and deeply connects one to the other.

The saliency/attention map generator 118 may be configured to generate a saliency map and/or an attention map 124 from the cross-modal embeddings 122 generated by the relational reasoning neural network 116 and/or from properties of the relational reasoning neural network 116, such as weights used by the relational reasoning neural network 116. A saliency and/or attention map, such as the saliency/attention map 124, for a neural network may be any visual representation of a focus of the neural network. Alternatively or in addition, a saliency map may include a data representation of attention and action vectors, which may be leveraged by the system 100 to communicate and align priorities of the agent to those of the human operator. In one example, the saliency/attention map 124 may include visual representations that highlight areas of the screen that map to the HO input at the current environment state, as well as the attention to an expected future state. In addition, one or more saliency maps may be created by the system 100 to identify the focus placed by the agent on the actions to be taken. The saliency/attention map generator 118 may use any technique suitable for generating the saliency/attention map 124, such as is described in “Deep Inside Convolutional Networks: Visualising Image Classification Models and Saliency Maps” by Karen Simonyan et al. and “Understanding Deep Learning Networks using Saliency Maps” by Ravikant Bhargava.

The agent neural network (not shown) may generate the actions and/or the policies based on the environment observations 112, the cross-modal embeddings 122, and/or the saliency/attention map 124. As a result, the agent neural network may base its choices of actions and policies based on historical observations of the value of such actions, policies, and environmental state.

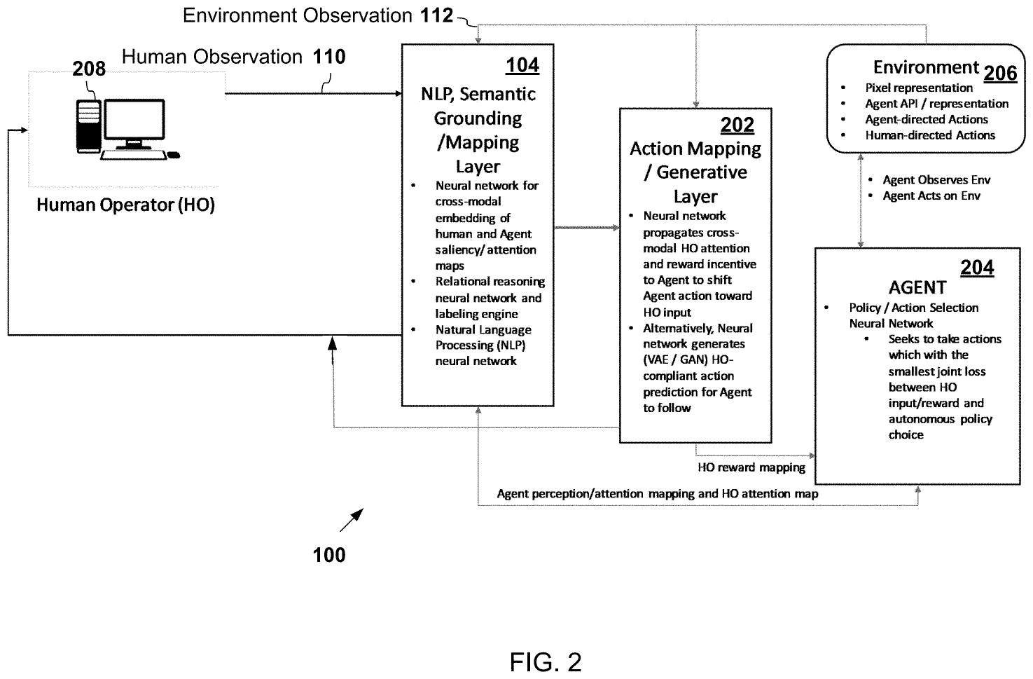

FIG. 2 is a data flow diagram for an example of the system 100. Components shown in FIG. 2 include the semantic layer 104, a generative layer 202, an agent 204, an environment 206 and a device 208 comprising a human-machine interface configured to receive human operator input. The human operator observation and input layer 102 is not shown in FIG. 2. The semantic layer 104, the generative layer 202, and the agent 204 may each include one or more neural networks to facilitate the translation of the HO Input into a form or forms such that the HO Input may shape the attention, environment perception, semantic labeling embeddings or vectors, relational reasoning modules, imitation-learning algorithm, and other agent inputs or algorithms, with the ultimate outcome of shaping the agent action or policy selection process to be more closely aligned with the HO input than may occur in the absence of such shaping.

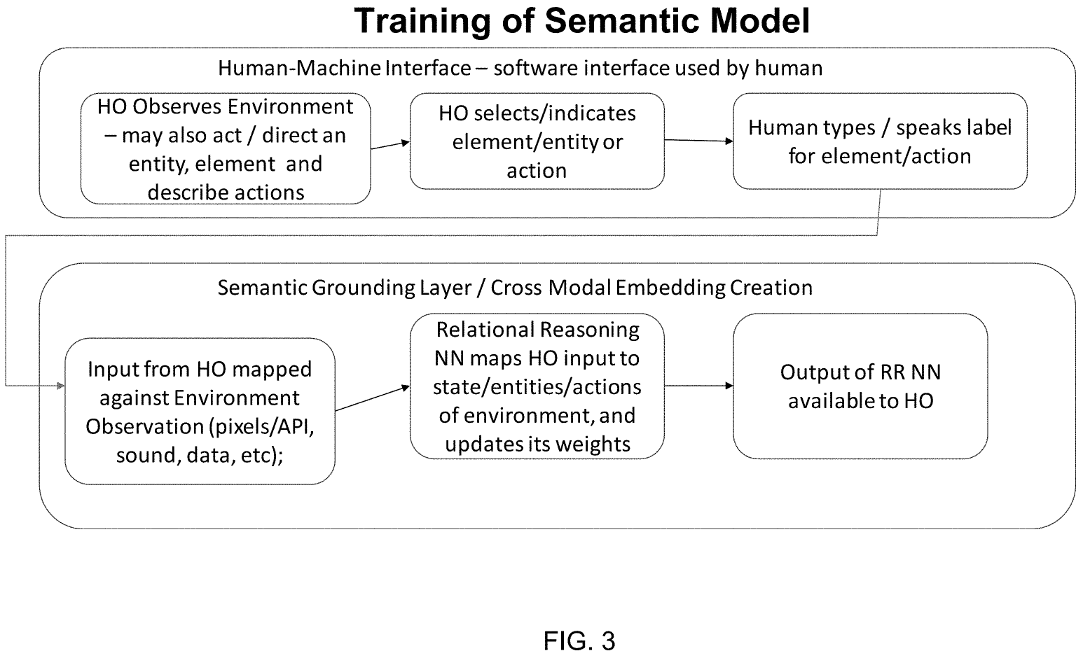

FIG. 3 illustrates an example method of training the semantic layer 104 of the system 100. The natural language processing neural network 114 may be trained by providing multiple human observations 110 and multiple environment observations 112 as input to the natural language processing neural network 114. As a result, the natural language processing neural network 114 may incorporate natural language understanding and human machine inputs, such as selection via click and/or touch in the form of the human observations 110. In some examples, the system may provide feedback to the human operator during the training. The feedback may be include output from the semantic layer 104 incorporating graphical or other display of Human Operator Input Mappings such as the saliency and/or attention maps 124, and their correspondence to output of the relational reasoning neural network 116, such as saliency/attention/label maps output showing the neural network model of representations, relationships, and actions in the environment.

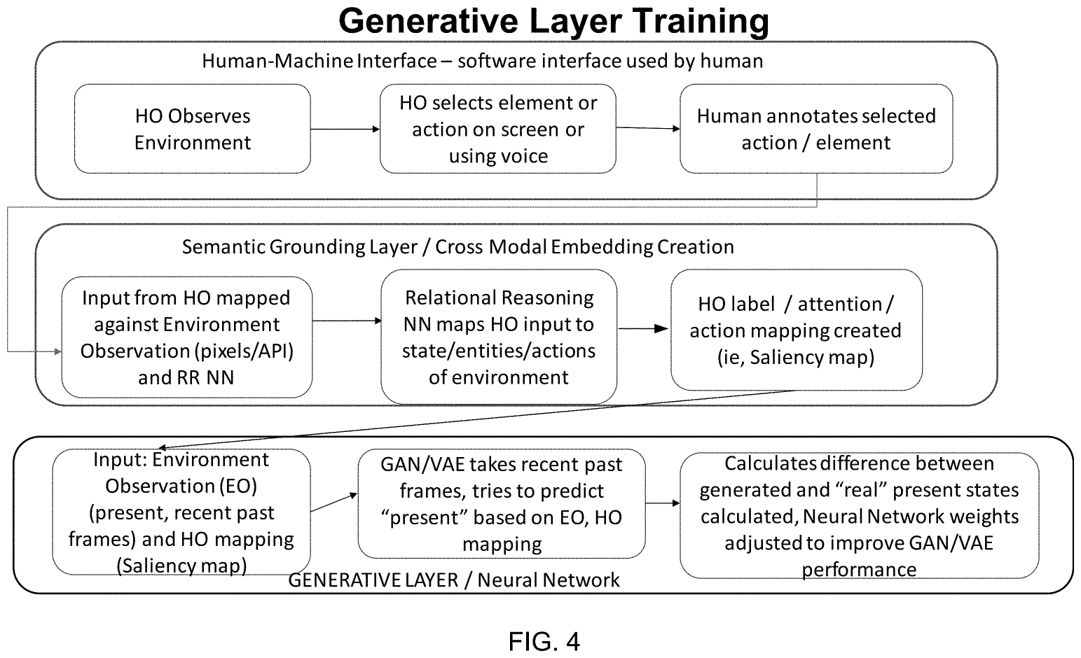

FIG. 4 illustrates an example of training the generative layer 202 of the system. The generative layer 202 includes a generative network configured to create a sequence of outputs consumable by an imitation-learning neural network and/or a curriculum-learning neural network included in the agent neural network. The generative network may include one or more generative neural networks, such as a variational auto-encoder and a generative adversarial network (VAE/GAN). HO Input Mapping in the form of the cross-modal embeddings 122 and/or current-step environment observations 112 may serve as input to the generative network in order to trigger the generative network to generate future frames, which may represent the next steps and actions that most closely approximate the future states desired by the HO. This generative content is produced via neural networks, which have been trained on past play (or more generally, past environment observations 112 and human observations 110) in order to develop a neural-network based environmental model or simulator, which learns to approximate the dynamics and interactions in the environment. These generative neural networks' training data may be combined with the cross-modal vectors/embeddings of the HO Input given concurrent with such past play, such that with HO Input Mappings during any given state, the generative networks may be constrained to produce predictions for future frames which are mutually compatible with both HO Input Mappings 122 and 124 and the observed state of the environment. This may be done by applying, for example, a conditional GAN algorithm as described in “High-Resolution Image Synthesis and Semantic Manipulation with Conditional GANs by Ting-Chun Wang et al. In other words, the sequence of outputs from the generative network may include a series of transformations or actions to be performed in the environment by the agent over an ordered sequence of timestamps aligned with one or more of the human observations.

These outputs may also be displayed to and evaluated by the human operator in the form of diagrams, schematics, pixel layouts and pixel layout sequences, action sequences, action representations, rule sets, audio, and other methods as appropriate for the domain, for clarification, confirmation, correction, or enhancement by the HO through further input. In some examples, the HO may then iteratively give feedback to amend or alter the way in which their input is captured in the Semantic Map, Representation, and action representations, and continue this iterative process.

The output of the Generative Layer 202 may then be passed on to the Agent 204 for processing by a module at the Agent layer which uses imitation learning or similar techniques to incorporate the output of the Generative Layer 202 such that the output of the generative layer 202 impacts and shapes the agent's policy and/or action selection. In other words, the sequence of outputs from the generative network may include a first frame representative a first state of the environment and a second frame representative of a second state of the environment, where an action and/or a policy from the cross-modal embeddings represents an action within the environment to be copied or approximated by the imitation-learning neural network or the curriculum-learning neural network of the agent in going from the first frame to the second frame.

The system 100 solves the technical problem of enabling humans to use natural language and human-machine-inputs, without programming knowledge, to influence and shape both the training and action or policy selection of the agent neural networks, which has been designed to learn autonomously, or through imitation learning.

Alternatively or in addition, the system 100 provides a technical solution that enables one or more Human Operator(s) (“HO”) or user(s) to describe an element or elements, or indicate a relationship between elements in an environment, or outline an action to be taken in regard to the environment and elements in the environment. The system 100 facilitates establishing a shared understanding or “mapping” between the human operator and Agent regarding the activity or element being described, and includes a technical solution that uses this shared mapping or understanding to increase the likelihood that any action or policy selected and/or avoided by the Agent in regard thereto is compliant and/or aligned with input provided by the human operator. The system 100 provides an innovative technical solution that enables human-influenced selections made by the agent to positively influence the neural network weights of the agent neural network in order to make the agent more likely to choose the human-input-compliant action for an equivalent environmental state in the future. The system 100 may also facilitate ad-hoc input during agent action selection, allowing the agent to adjust the agent's action selection during exploration of the environment as a function of the human operating input, making it possible to leapfrog unsuccessful action choices, which the agent may otherwise have needed to evaluate though large numbers of iterations and their value outcomes. Alternatively or in addition, the system 100 provides a technical solution to the problem of how to enable a human operator to use a few words to describe large number of actions, which the Agent may learn to carry out in response to the human observations that includes those few words.

Alternatively or in addition, the system 100 may combine a heuristic approach, inductive reasoning, and capabilities of a human with the scale and computing power of an autonomous-learning AI Agent.

Described herein are methods and systems for humans to directly shape the training process and learned behaviors of self-learning AI Agents via human input in the form of natural language, gestures, and human-machine-input (HMI) systems, incorporating a novel feedback system which provides the human operator with clarity about the action, behavior, or environmental descriptor to be propagated to or avoided by the agent, as well as the positive or negative value thereof in regard to the Agent's other goals, in a way that is also compatible with and complementary to the Agent's autonomous learning process. The system 100 may also make evident to the HO the extent to which the HO's input matches the agent's perception of the environment, and how the HO's previous input is mapped to labels, names, or descriptions for the elements, actions, and states of the environment. Alternatively or in addition, the system 100 may show representations to the HO of neural-network mappings of elements and actions in the environment at the Agent Layer, Semantic Layer, or Generative Layer, such as saliency maps as described in “Understanding Deep Learning Networks using Saliency Maps” by Ravikant Bhargava, or attention maps, as described in “Attention is All You Need” by Ashish Vaswani et al. Specifically, in the methods and systems described herein, a human operator may: provide information about the environment in which the Agent may act; describe the elements visible in the environment; talk about actions occurring between those elements; encourage or discourage action sequences being played out; and describe, act out, or otherwise demonstrate via a Human-Machine-Interface, actions to be performed or avoided by the Agent.

This disclosure outlines an example of an adapted reinforcement learning system incorporating four layers or modules, each of which may incorporate one or more neural networks, in order to create two primary channels through which Human Operator input and directives may be adapted into a form which shapes the action or policy selection of one or more AI agents in a given environment to be aligned with the intent of the Human Operator. With the system 100, human operator input may affect both training of the agent, impacting the agent's future action and policy selection, as well as affect real-time action or policy selection as the agent proceeds in the environment. In some examples of the system 100, one of the four layers—the Generative Layer 202—may be omitted while still maintaining one channel through which the Human Operator input may be used to impact the agent's action and policy selection and therefore fulfill one or more of the goals of the system 100.

In some examples, the system 100 may be deployed on environments in which the primary data source is visual data or input, and which may be augmented with various data points in regard to the elements, relationships, and actions displayed on screen, in addition to various reward metrics for agents or participants in the system, such as scores or similar success-benchmarking data.

In some examples, the system 100 may be deployed on environments where the primary data source(s) are based on data, text, combinations of text and data with visual formats, with music represented in any format including MIDI formats, waveforms, notes, and/or with a vast variety of other inputs and features, which may incorporate data outputs resulting from processing of other data fields and forms including style transfer (which is widely considered to have originated with “A Neural Algorithm of Artistic Style” by Leon A. Gatys et al.), as applied to visual, musical, or other domains. In such examples, the elements being referred to may be the musical notes, and their relationships may represent the interactions of the notes with one another and their interactions with one another (in other words, the melody which results from a given set of notes in a certain order, and the extent to which layers of notes played at the same time may create harmonies or discord). The environment may be software program that synthesizes music based on input from a human. For example, a human operator may direct the environment to generate a series of notes on a guitar. The agent may create notes. An example of an action may be to generate waveforms which represent a melody being played on a guitar instead of a piano.

In some examples, there may be four layers through which Human Operator input is mapped into a format which results in a shifting of agent action or policy selection shifting in favour of actions or policies which are compatible with the Human Operator Input, as follows

Layer 1. Human Operator (“HO”) Observation and Input Layer: This layer incorporates an output mechanism such as a screen, speaker, or other mechanisms that enable the HO to perceive the environment's state and the agent or element actions and policies being enacted within it, in combination with an input mechanism which may capture HO input via keyboard or other text input, speech or sound input, mouse, pointer, touchscreen, or similar indicator-based input mechanisms. Together these may be considered the human operator observation and input layer 102, which facilitates Natural-Language Human-Machine-Input (HMI), and this layer or module facilitates observation/perception of the environment by the HO and input by the HO to the system, as well as the transfer and parsing of such information to the second layer, such that the information may be mapped against the environment, and used to develop a shared (Human/Agent) semantic map of the environment in the next layer of the system.

Layer 2. Semantic Mapping Layer: This layer, the semantic layer 104, takes as inputs the HO Inputs and the environment observations (for example, both pixels and other visual representations, as well as all other data available about the state of the environment, including sounds, data, elements, and other features, and any other representations which may be available to the Agent, which may be mapped through a convolutional neural network with several hidden layers and a varying number of parameters or weights), and uses the relational reasoning neural network 116 to establish a cross-modal or multi-modal (using an algorithm such as is described in “Do Neural Network Cross-Modal Mappings Really Bridge Modalities” by Guillem Collell et al.) mapping or embedding incorporating the areas, elements, and actions which form the focus of the HO input (including, for example, language and pointing/selection indications, including labels, descriptions, and action-related input) and the environment state and data. The output of this Layer may be made available to the Generative Layer, to the Human Operator (via attention and saliency maps), and to the Agent directly.

Two neural networks may enable the Semantic Mapping Layer to create this cross-modal mapping, which represents in a compressed or low-dimensional form the interactions between HO input and environmental state, as well as to capture vectors for the actions to be taken or avoided for any given combination of environmental state and HO input: the natural language processing neural network 114 and the relational reasoning neural network 116.

Firstly, the natural language processing (“NLP”) neural network 114, which may be based on LSTM (long short term memory) networks, attention, or other algorithms, must be trained. The NLP neural network 114 may parse, map, and allocate labels or nomenclature to the relevant elements perceived by the HO in the environment, as well as the interactions between them, based on prior training data. This training data may take the form of a large number of environmental observations with accompanying labels from human operators, such as video, audio, data flows and interactions, and/or other replays of live environment interactions, accompanied by real-time labeling and commentary using similar input methods as layer 1 of the system. The neural network is trained using this data, meaning that an optimization process is run whereby the neural network tries to predict the labels conforming with a given environmental state in the data, and adjusts the weights or parameters in the network until the error rate is minimized, using techniques such as backpropagation or gradient descent, as appropriate given the algorithm chosen. Once trained, the network may generate its own labels for elements and actions perceived in the environment, which may be used for training of other elements of the system. It is then also capable of parsing HO input and allocating it accurately to the elements/actions in the environment.

The second neural network module of the Semantic Mapping Layer, the relational reasoning neural network 116, is trained to create a relational representation (“RR”/“RR Module”) of the environment state (as outlined in, for example, “A Simple Neural Network Module for Relational Reasoning” by Adam Santoro et al.), based on past training data from the environment. The RR module learns to disentangle the elements—and model the interactions between them—which occur in the environment, leading to the potential for better generalization of the system, creating a model for element interactions, and facilitating closer alignment of the system's representations with the way in which humans tend to perceive and describe the world through the alignment with the HO labels.

The use of this relational reasoning module and the incorporation of human-directed labels into its training may enable the system to generalize from the visual/pixel inputs it receives into reasoning and action choices based on the elements, relationships, and action sequences encountered and the labels attributed thereto by the HO. Because of human bias to attribute agency to elements and the way this bias may influence the relational reasoning module, it is possible that the relational reasoning module will acquire representations that are better able to generalize, e.g. be able to identify equivalent situations in new environments, which addresses a key technical challenge in artificial intelligence research.

The cross-modal embedding or vector output from this Layer is derived from HO input being passed through the NLP module to create element and action embeddings or vectors representing the human input, which are then mapped through the RR module to convert them into action vectors pertaining to elements in the environment and how they interact. The output of this layer, therefore, is not merely a semantic map or parsing of the human input, but a dynamic action mapping onto the current (and intended future) environment state based of the Human Input, which may be used by neural networks in other layers to align action or policy selection with the HO input, as converted into embeddings/vectors and mapped to the elements in the environment.

The cross-modal embedding/vector output of Layer 2 is the first channel through which HO input may be passed to the AI agent in order to align its action and/or policy selection with the HO input.

A graphical representation of the output of Layer 2 may be produced by means of Saliency or Attention maps, which may display/express to the HO an action-vector representation of his/her descriptions and instructions, and how they relate to and/or should influence the environment creating the potential for feedback and clarification by the HO as to the mapping by the system of the HO instructions, resulting in refinement of the system and increased likelihood of HO input being matched with agent action.

Training of the NLP module may seek to minimize the difference between the elements, actions, and relationships as extracted by the Relational Reasoning neural network and the HO input labels over time, in order to align the human labeling, embeddings and attention with that of the Semantic Layer and Agent Layer embeddings and attention. This makes it possible for the HO's focus and attention on elements and actions within the environment to influence of the Agent's perception of same, and to influence the Agent's priorities and goals to be more similar to those of the HO.

Layer 3. Action Mapping and Generative Layer: This layer, the generative layer 202, maps embeddings, vectors, and other factors received from Layer 2 derived from the HO input (“HOIM”, for Human Operator Input Mappings, which may be mappings, embeddings, vectors, or other forms of input) for elements perceived, and actions to be taken, by the Agent. In Layer 3, These HOIM are passed as inputs to a neural network incorporating conditional elements based on variational auto-encoders (VAEs), conditional generative adversarial networks (CGANs) or other, similar generative network (such as described in “What a Disentangled Net We Weave: Representation Learning in VAEs (Pt. 1) by Cody Marie Wild) to create a sequence of outputs (in the form of single- or multiple-timestep frames, sounds, actions or similar goals for the Agent), which communicate the HO's desired outcomes such that they may be consumed as an imitation-learning or curriculum-learning goal by the Agent.

In order for this Layer 3 to correctly map HOIM to output which may be consumed as actions or procedures to be imitated such that the Agent may successfully execute them, a generative network may be implemented and trained on relevant data. The training data from Layer 2 may be reused here as multiple-timestep sequences, whereby Layer 2 labels the environmental elements and actions which unfold over a series of frames as an input with the first frame, and uses the RR Module to export this as a vector/embedding representation of action sequences over the coming frames, and also passes a single frame representing the environment state at time or frame zero, plus the ending frame/environment state after n timesteps, and passes these to the generative network. The generative network uses the first frame to represent the environment at time zero, plus the action vectors/embeddings as inputs for the change to be modeled over the coming frames and, using gradient descent or other techniques as appropriate, seeks to predict the final frame at timestep n based on the combined inputs. Each frame-at-time-n prediction is then mapped against the actual outcome over the later or final frame(s), and the network adjusts its weights over time to limit or minimize the loss or error between the prediction and the actual outcome.

An alternative training method which may be used for the generative network is to select all previous sequences where the Cross-Modal vector/embedding output from Layer 2 matches the resulting actions over the coming frames, and use this input (including as above the first frame and time-n-frame) to train the generative model to predict the resulting frames. Similar to the above approach, the error is then calculated for each prediction and the network weights are adjusted to optimize the predictive capacity of the neural network. In other words, training the generative network may include finding sequences of frames in a training data set in which corresponding cross-modal embeddings generated by the relational reasoning neural network match when the relational reasoning neural network is provided a first frame in each of the sequences of frames as input. The generative model makes a prediction of future frames, the accuracy of the prediction is evaluated by the generative network against either the generative network's internal discriminator, which produces an accuracy score reflecting the accuracy of the prediction, or the actual evolution of the environmental state in subsequent frames, and where the weights of the generative model are then updated to improve the accuracy of future predictions in accordance with those accuracy judgements.

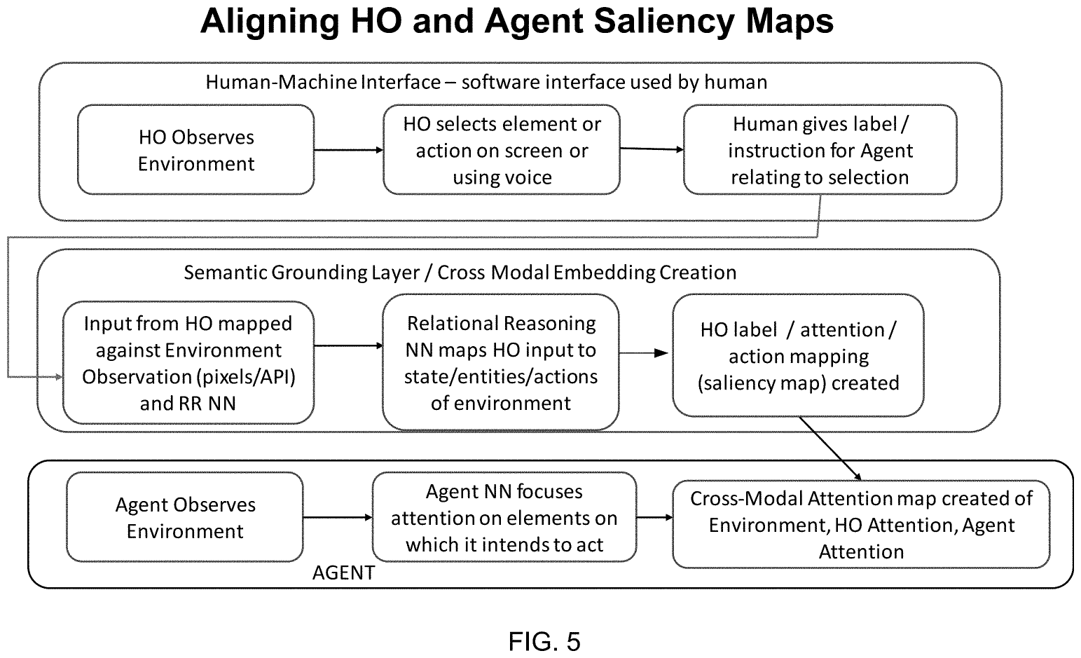

FIG. 5 illustrates an example of aligning human operator and agent saliency maps. To optimize compute and speed for either or both of the above options, this same process may also be replicated using attention, whereby only the elements and actions relevant to the HO input on the screen are predicted and the error calculated and optimized. Training the agent neural network may include: generating a first saliency map from the cross-modal embeddings; generating a second saliency map from an output of the agent neural network; and adjusting weights of the agent neural network such that the second saliency map is aligned with the first saliency map.

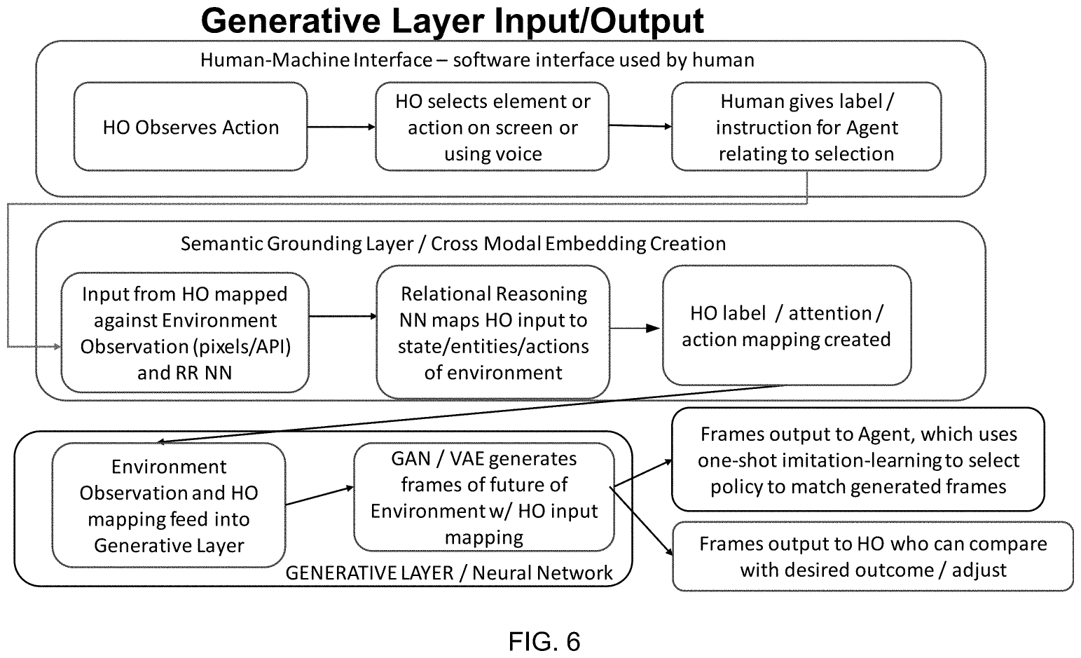

The resulting trained generative network is then capable of taking as inputs a given environment state and Layer 2 Cross-Modal embedding/vector output, and outputting an output (which for visual environments may be a frame or series of frames, and for other environments may be a series of transformations or actions to be performed in the environment by the agent) for coming timesteps which is aligned with the HO Input. FIG. 6 illustrates an example of generative layer input and output.

Any sequence generated by this Layer may also be displayed to the HO to represent the system's upcoming action representations to be passed to the agent, enabling the HO to understand the way their input has been interpreted by the system, and if necessary or desired, take steps to change or rectify the actions being proposed.

By establishing this a shared mapping of environment, labels, and upcoming actions, a bridge is established whereby both human operator and agent have a shared layer, interpretable by both, to facilitate joint understanding of the actions to be selected in the future. By generating a single- or multi-frame visual sequence representing the HO's desired actions, the Generative Layer's output enables the Agent to use an imitation-learning neural network to choose a policy or action which is aligned with the sequence displayed by the VAE/GAN.

Layer 4. This layer is the AI Agent action/policy selection and execution layer, using neural networks with RL or DRL models which select policies or actions based on vectors, embeddings, sequences, or inputs which come from one or more of several modules in the system 100, including three primary action- or policy-selection vector sources. This layer may also use a specialized experience replay system for training, the replay selection engine for which is linked to HO input vectors which align training with the human operator's input, as detailed below.

1) environment observations, which may include pixel-based or adapted representations and may include sound, data, and other factors or features from the environment, and which in any case incorporate the RR module output highlighting elements and interactions, whether or not these have been impacted by HO inputs regarding HO goals or attention vectors. These drive the autonomous reinforcement-or deep-reinforcement-learning neural network used by the agent for action selection, for which a wide range of action- or policy-selection algorithms may be chosen or deployed, such as PPO, DQN, RAINBOW, A3C, and including hierarchical or meta-learning variants, whereby the agent selects actions or policies which it estimates will lead to the highest reward over coming timesteps, and continually adjusts its learning during training until reaching a stable result (or does not converge). To the extent that experience replay is used, it is with of the experience replay (“ER”) module listed below, which incorporates a HO-input-related replay selection module. In the absence of human action embeddings or vectors flowing through the RR Module, this neural network will drive the Agent's action and policy selection just as would a vanilla implementation of such a network or algorithm, and may be expected to achieve similar results and performance as systems that use such algorithms exclusively. Where HO input has been provided, this algorithm receives an additional reward signal for selecting policies or actions which are aligned with such RR-Module-input, as detailed below:

2) Layer 2 relational reasoning module auxiliary goals, which may provide policy or action selection vectors or embeddings, in the event that HO Input Mappings exist, which may or may not include attention vectors, embeddings, labels, action descriptions and other factors. To the extent that the RR Module outputs provide one or more element/action vectors to be achieved by the agent, this is incorporated into its calculation of the value of policy or action selection via an auxiliary goal, the value or amplitude of which reward signal or goal may be optimized manually in the course of the system implementation, or manipulated in an automated or semi-automated fashion via a factor related to human feedback regarding alignment of the agent's behaviour with human input. In subsequent training of the network where such an additional reward function or auxiliary goal has been established, a penalty may be allocated to the agent for the extent to which the agent neural network chooses actions or policies which diverge from the auxiliary goal or reward, which will shift the network weights during training away from such divergent policies and toward HO-input-compliant actions. In the absence of HO input into a given environment state, the Agent will therefore be shaped by the HO input from previous rounds. Such penalties may decay over time in order to avoid constraining the network in perpetuity, and locking the agent into sub-optimal patterns.

3) a neural network based on imitation learning (such as is described in “One-Shot Imitation Leaning” by Yan Duan et al.), which may incorporate one or more of: algorithms such as DAGGER, as well as behavioural cloning, curriculum learning, one-shot imitation learning techniques, meta-learning, and temporal-difference alignment elements (see also, “One-Shot Imitation from Observing Humans via Domain-Adaptive Meta-Learning” by Tianhe Yu et al.) to establish which policies or actions are most closely aligned with the Generative Layer output. In some instances, this neural network will use HO Input attention derived from the RR module in order to focus the agent's imitation actions on the elements in the environment which are of greatest interest to the HO and seek actions or policies which are most closely aligned with those elements. Imitation learning (and the related concepts listed) algorithms generally seek to minimize the loss between the target outcome (in this case, the output of the Generative Layer) and the outcome generated by the imitation-learning algorithm, and output the resulting policy or action selection. This neural network module outputs a policy or action selection which may then be executed by the agent.

A method for training enhancement versus autonomous agents is also possible through a novel approach to experience replay. Training of the agent is enhanced and aligned with HO input through experience replays from the agent's replay buffer, which may or may not incorporate a separate memory module. The replay buffer uses a novel sequence selection mechanism based on HO input. In contrast to other experience replay mechanisms (such as described in “Distributed Prioritized Experience Replay” by Dan Horgan et al.), where relative success of a given policy is used to prioritize action and policy selection based on sequences and experiences from previous play, we use a sampling engine that gives priority to replays which have the closest alignment with HO Input from the RR Module. Mappings from the Relational Reasoning Module are paired with an auxiliary reward allocation to reflect the fact that the selection is an HO choice, which updates the neural network weights in favour of the action or policy chosen. Where no such closely aligned replays are found, the module selects based on conventional methods, and effectively reverts to the existing state of the art. The incorporation of experience replay in agent policy selection has been shown to materially improve agent performance and learning rates, and by combining replay with a selection engine which aligns the chosen replay sequences with RR module output, the system shifts policy and action selection toward HO-aligned choices.

The resulting core DL/DRL model is an integrated agent model (such as RAINBOW described in “Rainbow: Combining Improvements in Deep Reinforcement Learning” by Matteo Hessel et al.) which selects the policy or action which is expected to lead to the highest-value outcomes over time from the policies/actions proposed by the various sub-modules outlined above, being: a) policy value enhancement for alignment with HO input over attention and action vectors/embeddings, which is an auxiliary goal derived from the RR module, b) DQN, A3C or similar vanilla architectures, optimizing expected outcome based on historical training, which may include experience replay and the replay selection module which aligns replay prioritization with HO input alignment, and c) the imitation-learning module output policy or action selection. Both a) and c) may have variable auxiliary rewards allocated to them based on the HO satisfaction with the degree of alignment between HO input and agent action.

When the integrated agent policy or action selection with maximum value is derived, the according action(s) or action sequence(s) are executed by the agent, and the system updates the environment state after a given number of steps, triggering a new pass through of the system 100, and updating the layers with the new state and accordingly the updated mappings of the HO input (which itself may have been updated).

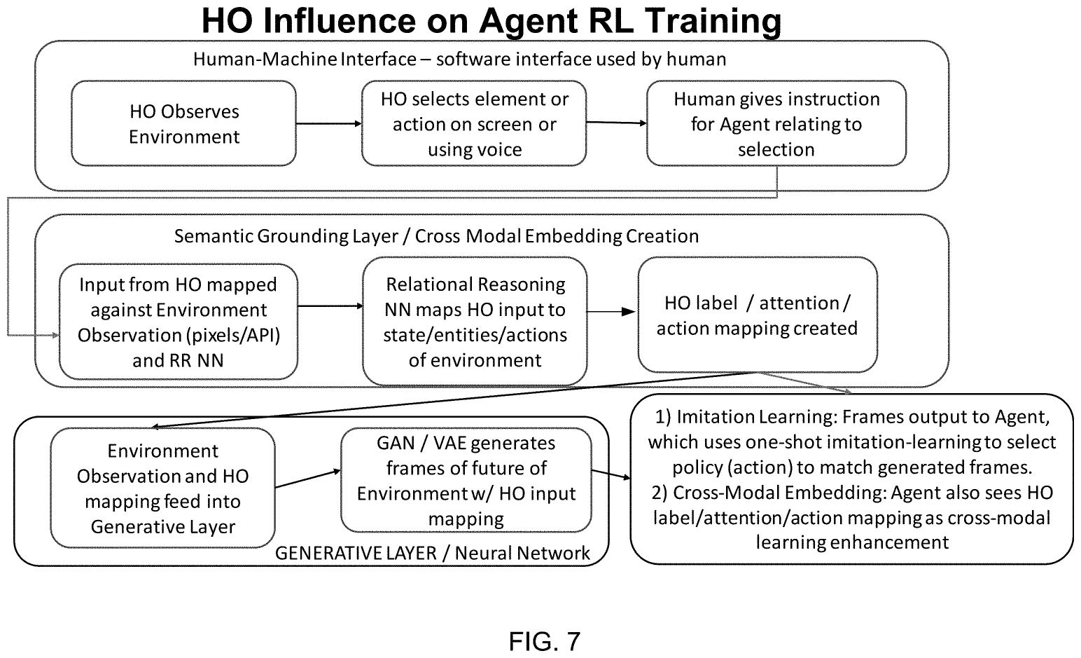

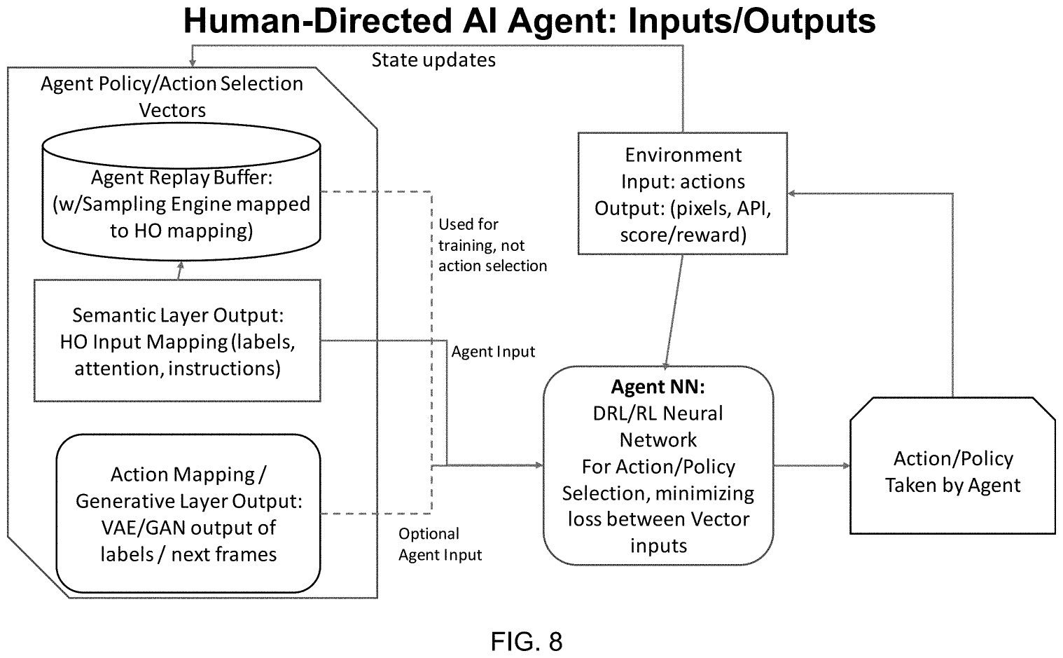

FIG. 7 illustrates a summary of an example of human operator influence on agent reinforcement learning training. FIG. 8 illustrates an example of human-directed AI agent input and output.

The system 100 may have ancillary benefits beyond optimization of any given environment. With many thousands or hundreds or thousands of such Agent instances in use, tracking of their learnings may lead to increasingly rapid training of human-directed AI Agents in new environments, and faster generalization and adaptation of Agent learnings to new scenarios and environments than is possible with current technology. This may be facilitated by the neural network layers of the platform and the resultant cross-modal mapping between the HO Input Mapping (instructions, descriptions, and labels) and the algorithmic element, relationship, and action classifications using relational reasoning. This may lead to an abstract representation of environmental elements which generalize, which once available across a number of different environments may help to boostrap relatively successful Agent choices in new environments at a level not possible without such intermediate representations. This may be seen as creating an interim set of representations akin to how adults help children to learn things—children observe the environment, adults and/or others label and instruct children about that environment and the elements and relationships between the elements, and adults coach the children to perform actions within the environment or allow the children to explore their own actions. As the children act, the children learn both at the level of the environment, and in the wider context of the elements and relationships which were explained to the children. When the children see similar elements to those labeled/observed in a different situation or environment, the children may infer with some success as to the outcomes if the children act upon those elements. Accordingly, the children are more likely to make good decisions about their own actions than if the children had never seen those elements before.

In some implementations, the human may also not be presented—through choice or as a fixed deployment setting—with the output of the generative layer, thereby skipping the step of review and feedback from the user. The system 100 in this instance then builds a semantically and environmentally-relevant map of HO input at the Semantic Layer, which may or may not be displayed to the user via saliency maps, and/or attention maps and labels, and then passes this output to the Action Mapping/Generative Layer to produce a simulation or projection of the HO's desired actions, and passes this on to the Agent in a way to influence the Action or Policy selection by the agent. Other prior art methods of impacting Agent learning have not presented methods for successful shaping of Agent training or action selection for scenarios that the Agent has never seen or which have not previously been encountered, nor have methods previously been presented which cross-modally map HO semantic and HMI input against environment mappings, relational reasoning neural network modules, and Agent-level attention and goal vectors in such a way that the neural network representations in the system and at the Agent level effectively incorporate HO semantics and intent in the action or policy choices made by the Agent—and thereby incorporate human intent in Agent policy selection in novel or unseen environments or environment states.

The process by which the HO may gather feedback on the extent to which the HO Input Mapping is accurately captured in the labels, embeddings, vectors, generated sequences, or other representations may be iterative, or the HO may not choose to review such representations and allow the System to incorporate them without review. In such instances, the HO may effectively treat Agent action or policy selection as a proxy for how successfully the HO Input Mappings are being captured and transferred to the Agent by the System. In any case, the representations available at the Semantic Layer, Action Mapping/Generative Layer, and Agent Layer may be passed to the HO through a variety of processes in order to enhance HO understanding of the System's progress and any clarification required in order to align the System's representations with the intent of the HO.

The System is unique and novel in several different ways, most of which derive from the architecture being the first to incorporate human intent and directives into RL/DRL Agent Action and Policy selection, both in real-time, and progressively over time through training. Firstly, the System may be considered unique in its iterative quality and the fact that the process creates a robust, grounded semantic map and multi-modal verified human/environmental input to the Agent learning process.

Second, the system may enable a human operator to reliably and clearly direct the learning process of an otherwise-self and/or autonomous-learning AI Agent with natural language and HMI (human-machine-interface), without the human operator possessing technical AI knowledge, and without the constraint of only using previously seen activities and/or scenarios—and, in some cases, feedback thereupon—to shape Agent learning.

Impacting the learning process of an AI Agent is an activity currently limited to AI experts. The systems and methods disclosed herein may enable any normal person to shape the learning of AI Agents and impact their algorithms, actions, and output without deep technical knowledge, with applications in drug discovery, data science, robotics, music creation, and games.

Alternatively or in addition, the systems and methods disclosed herein may create much steeper and faster learning curves for Agents than through unsupervised, autonomous learning. Because users may give input anytime during the learning process, Agents avoid unsuccessful strategies and, thereby, may learn more quickly than some alternatives.

Alternatively or in addition, the systems and methods disclosed herein may save time and monetary investment on training and learning iterations, as well as trial and error, to develop AI-driven products and services. This enables users to establish actions and domains that are off-limits to the Agent even if they have not been recorded or experienced by the Agent.

Alternatively or in addition, the systems and methods disclosed herein may addresses a shortage of AI developers by giving tools to companies to enable the companies to use AI technology, which the companies may otherwise not be able to deploy due to (expensive) technical talent currently needed to use recent advances in AI technology.

Alternatively or in addition, the systems and methods disclosed herein may enable people to work in concert with AI to produce higher levels of performance and innovation. Humans may be able to give feedback to enable AI to successfully navigate AI-unfriendly areas, such as those requiring strategic thinking, inductive reasoning, planning, reasoning under sparse data.

The system 100 may be implemented as a flexible AI platform incorporating four distinct layers in some examples, which may be deployed into any target domain.

In games and robotics, the Agent and the user initially interact through demonstration and description of the possible game actions and strategies, again evolving “symbol grounding” for discussion of the actions and strategies of the game.

The Agent may then highlight its own ‘tagging’ process of the environment, and through user feedback, this evolves until both user and Agent are “speaking the same language”.

Both in games and data, this avoids needing “cognitively plausible symbol grounding” for the broader world (in other words, the Alexa/Siri problem described in “Siri and Alexa Can be Hijacked with Inaudible Messages, Researchers Warn” by Cara McGoogan)—but it may reasonably evolve and/or be developed in these micro-environments, within a time frame which is acceptable for the human operator.

Current AI solutions and technologies are “narrow” AI—designed to learn and/or optimize for one class of task such as video captioning, image identification, or autonomous driving, with little capacity to transfer learnings from one task to another. Research in AI is generally focused on moving toward “General” or “Strong” AI, which would be capable of inductive reasoning and abstract thought, and capable of making associations and transferring learnings across domains.

Until general AI arrives, domains in which inductive reasoning, creativity, long-term planning, or other kinds of broad insight are required will be dominated by humans. The system 100 may empower those humans and their creative, inductive-reasoning talents with the powerful computational capacity of AI.

People may use natural language and other “natural” interfaces to direct customized AI agents within specific domains in order to achieve more than those humans could achieve on their own.

Different Human Operators may train their agents differently to approach the same problem, developing different strategies to progress and/or succeed in the same environment. For example, in massively multiplayer online role-playing games (MMOPRGs), different strategies (such as aggressive & conquer vs. defensive & gather) may be developed by the Human Operators. The different strategies implemented by the respective agents may complement, and/or compete with, each other.

The methods and systems described here may also address the challenge of many domains, not least of all the large and challenging “black box” problem of AI.

The Agents merge strong bodies of recent work in relational and visual reasoning, disentangled representations of environments, and dialogue models with advances in complex reward functions and human-in-the-loop systems. The system 100 is the first platform designed for non-technical, end-user deployments in valuable spaces, such as financial trading, medicine, and music generation, as well as providing characters that adapt to and serve players, enhancing interactive experiences for game and VR/AR domains.

At present, within a given environment, there is no method or platform which provides a mechanism for a user to describe an element, or indicate a relationship between elements in an environment, or outline an action to be taken in regard to the environment and its elements, whereby the method or platform ensures that a full understanding between the user and Agent regarding the precise activity or element being described is in fact established, and ensuring that any element or action being directed by the user to be taken/avoided by the Agent in regard thereto is compliant with input provided by the user. This method may also facilitate input in real-time, allowing the Agent, for example, to constantly adjust its strategy, leapfrogging unsuccessful strategies, which the Agent would otherwise have needed to evaluate though large numbers of iterations.

The technical improvements which result from the system 100 may include one or more of the following:

1. To enable experts in a given field who are not also AI experts the opportunity to direct and deploy AI data analysis agents iteratively in order to solve problems and extract insights.

AI cannot normally be applied without deep technical AI knowledge, including algorithms and methods (Masters/PhD level). Agents will our iterative structure to discover mutual semantically grounded (natural language) representations (between user and AI), such that the non-technical HO may leverage AI algorithms (again, speaking naturally, evolving a common language with its Agent) to extract value from the data.

2. Create successful agent behaviours through verbal coaching.

With the system, a player may direct an agent in a game environment, either via training examples and input, or through in-play input. A player may also play alongside such an AI agent and direct it to perform tasks desired by the player. This may enable entirely new classes of Esports to emerge using such agents and such agent/coach teams. Similarly, the system may enable traders or drug discovery researchers to direct AI agents to quickly iterate through combinations and correlations in data that they would themselves otherwise search/experiment upon manually, or for which they would need to engage with data science or machine learning or AI experts. By combining agent computational capacity with human intuition, it is possible that this combination of inductive reasoning with agent computational power will achieve results that neither non-AI-assisted humans nor AI-only agents might not natively attain.

3. Coach robotics platforms (for example, port cranes).

Through demonstration and verbal feedback to shortcut learning processes and quickly drive approximate emulation of optimal or desired performance/movement.

As a result, the system 100 may provide one or more of these technical improvements in the capabilities of a computer or any other processing device.

The system 100 may be implemented with additional, different, or fewer components. For example, the system 100 may include a memory and a processor.

The processor may be in communication with the memory and a network interface. In one example, the processor may also be in communication with additional elements, such as a display. Examples of the processor may include a general processor, a central processing unit, a microcontroller, a server, an application specific integrated circuit (ASIC), a digital signal processor, a field programmable gate array (FPGA), and/or a digital circuit, analog circuit.

The processor may be one or more devices operable to execute logic. The logic may include computer executable instructions or computer code embodied in the memory or in other memory that when executed by the processor, cause the processor to perform the features implemented by the logic. The computer code may include instructions executable with the processor.

The memory may be any device for storing and retrieving data or any combination thereof. The memory may include non-volatile and/or volatile memory, such as a random access memory (RAM), a read-only memory (ROM), an erasable programmable read-only memory (EPROM), or flash memory. Alternatively or in addition, the memory may include an optical, magnetic (hard-drive) or any other form of data storage device.

The system 100 may be implemented in many different ways. Each module, such as the HO observation interface 106, the environment interface 108, the natural language processing neural network 114, the relational reasoning neural network 116, the saliency/attention map generator 118, the generative network, and the agent neural network, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of the memory, for example, that comprises instructions executable with the processor to implement one or more of the features of the module. When any one of the module includes the portion of the memory that comprises instructions executable with the processor, the module may or may not include the processor. In some examples, each module may just be the portion of the memory M or other physical memory that comprises instructions executable with the processor to implement the features of the corresponding module without the module including any other hardware. Because each module includes at least some hardware even when the included hardware comprises software, each module may be interchangeably referred to as a hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system 100 may be distributed among multiple elements, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL)).

The system addresses a need which arises as AI agents are beginning to be created for in game, simulation, and real-world environments which have the capability to align their action selections with human input. The presence of a human-adaptive AI Agent in an environment creates a need for a means or channel through which human intent can be conveyed to the Agent, and the proposed system solves this problem.

The solutions described herein enable a human operator to use natural human voice input or commands, combined with voice channels, which are either already present within an environment, or which may be created, to convey voice commands or input directly into the environment. The system provides a method through which once the voice input is available to the Agent in the environment, it can be processed into a format through one or more transformations which convert that voice input into a form which is compatible with the AI Agent's environment observation and action selection processes.

Historically, reinforcement learning agents in both real-world and simulated environments have autonomously selected optimal actions for a given environment state and observation. Communication with human operators was not a part of such systems, and accordingly no channels between human operators and AI Agents were created.

However, many new and proposed deployments of such agents will require, or will materially benefit from, combining their own environment state observations with real-time human input about which actions the AI Agent should prioritize. This enables a human operator to take knowledge and context into account which may not be directly available to the AI Agent in the environment. Thus, the human input may take this or other factors and considerations into account, and accordingly lead to a better result than the AI Agent could achieve without having access to such input.

The solutions described herein convey human intent via voice input into an environment in which a human-adaptive AI agent is present, and converting that human input into a form in which it can be used to align the AI Agent action selection with human intent, and then making that form available to the AI Agent.

AI Agent actions are aligned with human intent in real-world or simulated/game environments through two key functions, which work in a specific and innovative way. The first function is that the system directly conveys human input in voice form to an AI agent operating within a simulated or real environment. The second is that it uses a neural network running locally within the environment to interpret the voice input in the context of the environment state and uses that output to align AI Agent action selection with the human voice input as a function of the observed environment state. This combination of features is not present in existing systems.

This combination of features enables AI Agents to select actions for a given state within an environment which are compatible with human voice input, even as the environment state changes. This is possible because the combination of voice neural network and AI Agent can continually re-interpret the human language instructions in their native form, rather than as a vector or representation which may be connected to a past environment state, and thus no longer accurately represents human intent.

A system which uses a neural network to process human language to achieve a certain goal with such language may be considered to be performing Natural Language Processing (“NLP”). We co-locate the Natural Language Processing (“NLP”) system within the simulated or real-world environment, which both takes advantages of widely available voice channels in game, simulation, and real-world environments, but also enables the AI Agent to continually re-interpret complex or multi-objective commands in the context of the environment, avoiding the problem of a command being mapped to a static reward function or AI Agent objective based on a previous environment state. In real-world environments where communications with AI Agents may not be assured to be continuous, such approaches may lead to reward functions and AI Agent action selection which no longer align with human objectives as the environment changes.

This system presents a further advantage in that it enables AI Agents to be run entirely within simulation and game engines with no custom integration of pre-processed natural-language-related data required, in whatever formats this may exist. Game and simulation engines do not at present tend to offer a facility to integrate with external natural language processing data or engines as inputs to their environments. However, most game engines, some simulation environments, and many real-world environments have voice inputs, or can easily add this feature.

Processing locally, meaning internally within the real or game/simulation environment, is therefore a potentially valuable way of transmitting the human intent input to any AI Agents which may exist within the environment.

The system converts human voice into AI Agent action by transmitting or conveying human voice input directly into the simulated or real environment in which the AI Agent is operating using voice input modules or application programming interfaces or other methods. The choice of transfer modality has no effect on the functioning of the system, as long as it can be achieved without a delay which would exceed the time during which the environment state would materially change to render the input invalid or irrelevant.

The system resolves the intent of the human by means of a Natural Language Processing (“NLP”) module which is located locally in the environment, e.g. runs alongside the AI Agent in the game, simulation, or local Agent environment, has access to similar environment state information, and can interact directly with the AI Agent. This NLP module directly converts the human voice input into a format which can be used to align the AI Agent's action selection within the environment as a function of the environment state, and can update the interpretation of the human input in the context of the environment as it changes.

An example of such a system might be a soldier communicating via radio with a real-world environment, in this case an unmanned aerial vehicle (UAV) operating near the soldier, with the “environment” from the perspective of this system meaning processors and sensors running locally on, and controlling, the drone/UAV (unmanned aerial vehicle) platform. The soldier does not have a computer to turn his voice commands into another format. His voice commands are directly conveyed to the UAV/environment, which uses the NLP module to interpret his instructions, and then uses the AI Agent neural network to make action selections based on that input and on the state of the environment, as perceived via its sensors. If the soldier says “report any contacts around the yellow building ahead”, this is transmitted to the UAV “environment” comprising the UAV processors, sensors, and AI Agent neural network, as well as NLP neural network. The UAV receives the voice command. This is passed through the NLP module and converted into a representation which the AI Agent can map against its current environment observations. Then the UAV executes the action sequences which are compatible with the human input, i.e. flying around the yellow building and reporting any contacts it sees.

Another example of such a system might be a game console such as a Sony PS4 or Microsoft XBox running a computer game which runs within a “game engine”, such as Unity or UE4. The game engine is the “environment” in this case—as the game progresses, it generates environment state representations which the AI Agent can perceive and use to choose its actions. The game engine also hosts the NLP module, and provides a channel through which voice input is directly transferred from talking players into the game engine itself. This voice channel may exist across the various device types on which the game engine and game can be run—primarily to facilitate communication with or cooperation between human players. But it is available via the game engine to the AI Agent as well. In this example, the human player can play alongside an AI Agent, or with the AI Agent acting out his desired actions, by using voice commands to direct the AI Agent to carry out the human player's desired actions. For each human voice instruction received, the NLP module converts the voice to AI Agent compatible form within the game engine/environment itself, and the AI Agent can take this into account as it makes its action selections.

Accordingly, the solutions described herein enable humans in real, simulated, and game environments to shape the behavior of human-adaptive AI Agents using voice input in any environment in which it is possible to convey human voice to an NLP module and run AI Agents which can use the NLP module to interpret the human voice input in the context of the environment and its state, and adapt their action selection accordingly.

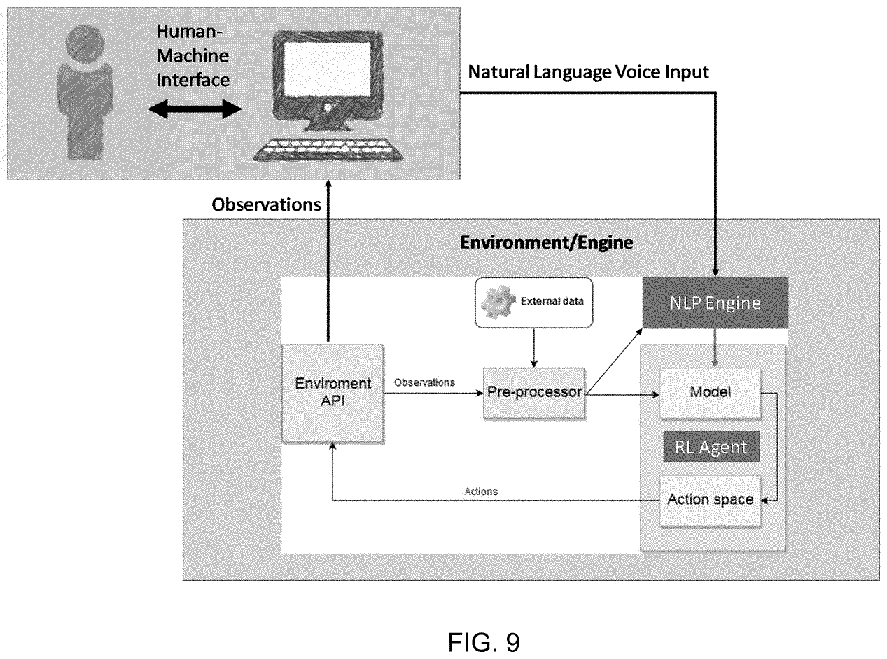

FIG. 9 shows an example of the entire system and the ways in which main components of the system interact. The Human Machine Interface may be any kind of display or audio device which can convey to the human operator information about the environment, as well as a microphone which can capture and transmit human input to the Environment/Engine module.

The Environment/Engine module includes the entire game/simulation engine (or real-world environment), and includes several components: The Environment API may be the module which transmits updates about the environment to the human operator, as well as to the AI Agent and NLP Module. In the case of a real-world environment, this may be the sensor data taken in by the agent. The transfer of these observations to the AI Agent and NLP Module happens via an optional pre-processing step for mapping of the environment observation into a form consumable by the AI Agent, and which may take other external data into account in some example. In a real-world environment, this may result in aggregation of external observations or measurements, and their fusion for a more comprehensive view of the environment. The green-shaded box contains the reinforcement learning agent, running TensorFlow or a similar platform such as Keras, PyTorch, or others. The Agent has access to the human input via the NLP module, and to the pre-processed environment observations. The AI Agent chooses its actions (Action Space box) based on all of those inputs, and executes those actions in the environment.

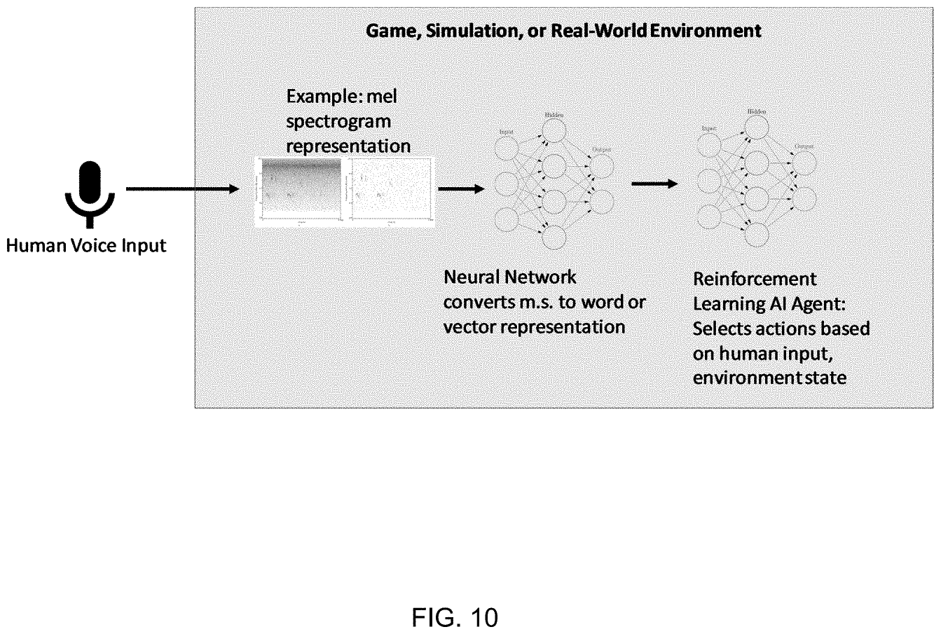

FIG. 10 shows an example of how the voice input from the human operator may be converted into a form which enables the agent to select actions which are compliant with the human input. As displayed here, human voice is converted into an audio format which can be transferred into the environment in which the AI Agent is active. In this example, which demonstrates one possible implementation, the voice input is converted within the environment into a mel spectrogram representation, and a neural network converts that mel spectrogram into a word or vector representation which can be shared with and interpreted in the context of the environment by the AI Agent. Other interim voice representations such as Lofargrams may be used as alternatives to mel spectrograms, and a variety of neural networks can be deployed which convert these interim voice representations into a vector, a series of words, or other representation which the agent can use to align its action selection with the human input.

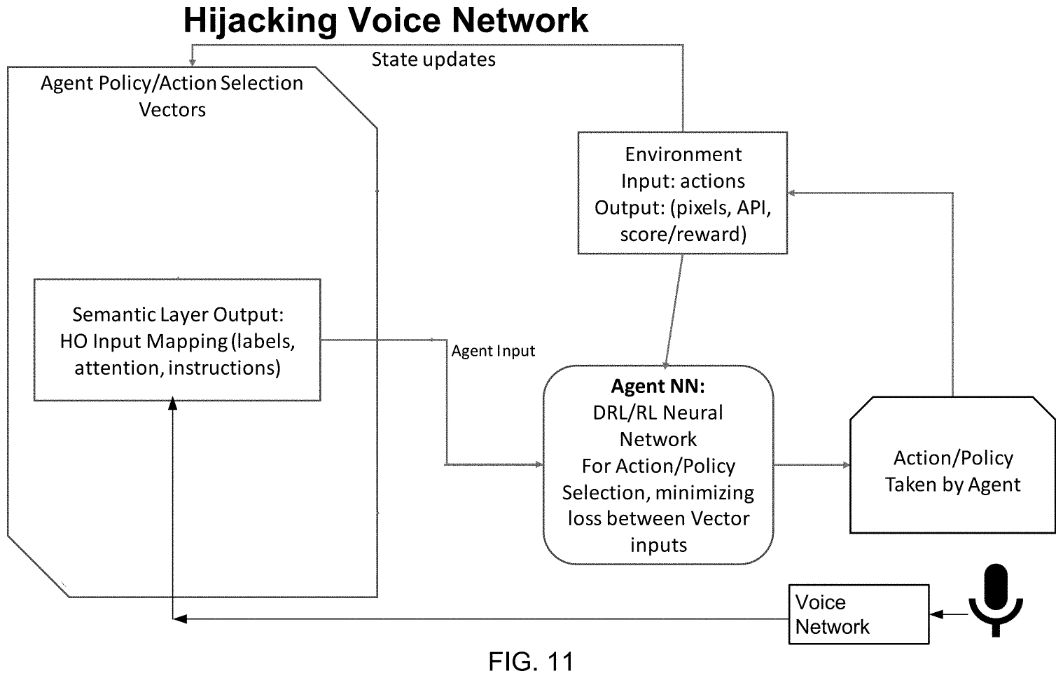

FIG. 11 shows a specific example of hijacking a voice network module in order to obtain the human observation in voice format. The voice network module may be any component designed to communicate human voice over a communication network to remote devices. Examples of the voice network module may include a voice chat service, a video chat service that includes a voice channel, a radio headset, and an app or an application configured to communicate voice data to one or more remote devices. The app may be, for example, an app installed in a mobile device, such as a smart phone or a tablet computing device.

The voice network module may be integrated with the environment. For example, the voice network module may be included in a gaming environment, for example included in a real-time development platform such as the real-time development platform sold under the mark UNITY® (a federally registered trademark owned by Unity Technologies). Although the voice network module may be included for communicating with other human operators, the system described herein surprisingly may use the voice data obtained by the voice network module for an entirely different purpose. Namely, to use the voice data to obtain the human observations from within the environment. Therefore, the use of voice data obtained from the voice network module may be considered to be “hijacking” the voice data.

The logic shown in any flow diagram may include additional, different, or fewer operations than illustrated. The operations may be executed in a different order than illustrated.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, elements, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more items selected from the group comprising A, B, . . . and N. In other words, the phrases mean any combination of one or more of the items A, B, . . . or N including any one item alone or the one item in combination with one or more of the other items which may also include, in combination, additional items not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A computer readable storage medium comprising computer executable instructions, the computer executable instructions executable by a processor, the computer executable instructions comprising:
instructions executable to generate, based on an agent neural network, a plurality of actions and/or a plurality of policies for an environment, the environment comprising an apparatus and/or a software component, wherein the actions and/or the policies may be enacted in the environment;
instructions executable to receive a human observation from a voice network module and a plurality of environment observations and output, based on a natural language processing neural network, a plurality of encodings of labels for entities, actions, and/or policies, wherein the environment observations are indicative of states of the environment, and wherein the human observation represents an observation of the environment made by a human; and
instructions executable to generate, based on a relational reasoning neural network, a plurality of cross-modal embeddings from the environment observations and the encodings of labels for entities, actions, and/or policies, wherein the agent neural network is configured to generate the actions and/or the policies from the environment observation and the cross-modal embeddings.

2. The computer readable storage medium of claim 1, wherein the voice network module is a voice chat feature of a game and the environment includes the game.

3. The computer readable storage medium of claim 1, wherein the voice network module includes a voice chat service, a video chat service that includes a voice channel, and/or a radio headset.

4. The computer readable storage medium of claim 1, wherein the voice network module is an app or an application configured to communicate human voice over a communication network.

5. A method of controlling an artificial intelligence agent, the method comprising:
receiving voice data representing a human observation, the voice data extracted from a voice chat service of a video game and/or a video chat service of the video game, wherein the voice chat service and/or the video chat service is configured to enable voice communication between human players of the video game, and wherein the human observation represents an observation, which is made by a human, related to the video game;
receiving a plurality of environment observations from the video game, the environment observations representing states of the video game;
outputting a plurality of encodings of labels for entities, actions, and/or policies from a natural language processing neural network by applying the environment observations and the human observation as input to a natural language processing neural network;
generating, based on a relational reasoning neural network, a plurality of cross-modal embeddings from the environment observations and the encodings of labels for entities, actions, and/or policies;
generating a plurality of actions for the artificial intelligence agent to take in a video game by applying the environment observation and the cross-modal embeddings as input to an agent neural network, wherein the actions for the artificial intelligence agent is to take are outputs of the artificial intelligence agent; and
causing the artificial intelligence agent to take the actions generated by the agent neural network.

6. A method of controlling a vehicle, the method comprising:
receiving voice data representing a human observation, the voice data extracted from a voice channel configured to enable voice communication between a vehicle operator and other humans, wherein the human observation represents an observation made by the vehicle operator related to a vehicle;
outputting a plurality of encodings of labels for entities, actions, and/or policies from a natural language processing neural network by applying a plurality of environment observations and the human observation as input to the natural language processing neural network, the environment observations representing states of the vehicle;
generating, based on a relational reasoning neural network, a plurality of cross-modal embeddings from the environment observations and the encodings of labels for entities, actions, and/or policies;
generating a plurality of actions for the artificial intelligence agent to take by applying the environment observation and the cross-modal embeddings as input to an agent neural network, wherein the actions for the artificial intelligence agent is to take are outputs of the agent neural network; and
causing the artificial intelligence agent to take the actions generated by the agent neural network, wherein the actions control the vehicle.

7. The method of claim 6, wherein the vehicle is an aircraft.

8. The method of claim 6, wherein the vehicle is a drone.
